(19) United States
(12) Patent Application Publication
(10) Pub. No.: US 2026/0336844 A1
(43) Pub. Date: Oct. 29, 2026

(54) CONTROL EQUIPMENT FOR DRONE HANGAR

(71) Applicant: Hollyway Group Pte. Ltd., Singapore (SG)

(72) Inventor: Larry LEE, Singapore (SG)

(21) Appl. No.: 19/188,039

(22) Filed: Apr. 24, 2025

(51) Int. Cl. B64U 80/25; A62C 3/00; G06N 3/0442

(52) U.S. Cl. CPC B64U 80/25; A62C 3/002; G06N 3/0442

(57) ABSTRACT

Control equipment of a drone hangar provided by the present application comprises: constructing a time series for water level information, lightning information, environmental weather information, historical water level information, historical lightning information, and historical environmental weather information, and determining a safety parameter of a next time period of a current time period based on the time series, safety parameter trend data, and a safety prediction model, and controlling the startup or shutdown of the drone hangar based on a predicted safety parameter. Since the safety parameter can ensure the safety of startup or shutdown of the drone hangar, the safety parameter can further guarantee the safety of drone operations. The timely startup of the drone hangar at future points in time can improve the operational efficiency of the drone and save the time consumed by determining the safe operation of the drone hangar based on current environmental data.

### TECHNICAL FIELD

The present application relates to the field of drone technology, and more specifically, to control equipment for a drone hangar.

### BACKGROUND

With the rapid advancement of drone technology, drones have been widely applied across various fields, comprising but not limited to environmental monitoring, power line inspections, traffic management, agricultural crop protection, and security surveillance. However, under harsh environmental conditions such as strong winds, heavy rain, hot temperatures, or low temperatures, both the flight and parking of drones face significant challenges. Drone hangars, which serve as storage, charging, and maintenance hubs for drones, play a critical role in ensuring the safe operation of drones.

In adverse environments, if a drone hangar is opened, elements like rain, snow, and lightning can not only interfere with operation of the drone hangar, but also cause severe damage to the drone hangar. For example, during a heavy rainstorm, if the hangar is not closed in time, water could seep into the interior, leading to moisture damage to the drone, battery short circuits, or other damages. In high-temperature conditions, if the hangar fails to activate cooling systems in time, the drone could overheat and become damaged.

However, in the prior art, environmental data at the current point in time is used to determine whether the drone hangar can be opened, thereby ensuring its safe operation and ensuring the safe flight of the drone. However, environmental data is constantly changing, and the prior art cannot predict whether the drone hangar can be safely activated at a future point in time. This could result in the drone hangar being unable to operate in time when it needs to activate at a future time, affecting the efficiency of drone operations. Additionally, in the prior art, real-time acquisition of environmental data still requires determining whether the current environmental data meets the safe operational requirements of the drone hangar, and this determination process will waste a significant amount of time.

### SUMMARY

The purpose of the embodiments of the present application is to provide control equipment for a drone hangar, which solves the problem in the prior art of being unable to predict whether the drone hangar can be safely activated at a future point in time to ensure the safety of takeoff of the drone, improving the efficiency of drone operations, and the large amount of time consumed in determining the safe operation of the drone hangar based on current environmental data. According to one aspect of the present application, control equipment for a drone hangar is provided, wherein the control system at least comprises: a control module, an execution module, and a detection module, wherein, the control module is separately communicatively connected to the execution module and the detection module;
the detection module is used for collecting operational execution safety parameters for a current time period, wherein, the operational execution safety parameters comprise various environmental information, the environmental information comprising water level information, lightning information, and weather information, the weather information comprising temperature, rainfall, snowfall, wind speed, and wind direction;
obtaining historical operational execution safety parameters for historical time periods; wherein, the historical safety parameters comprise various historical environmental information, the environmental information comprising historical water level information, historical lightning information, and historical weather information, the historical weather information comprising historical temperature, historical rainfall, historical snowfall, historical wind speed, and historical wind direction;
constructing a time series based on the water level information, lightning information, weather information, historical water level information, historical lightning information, and historical weather information; wherein, the time series has corresponding safety parameter trend data;
at the same time, determining a safety parameter for a next time period of the current time period based on the time series, safety parameter trend data, and a safety prediction model;
the control module is used for generating a first control instruction based on the safety parameter, and sending the first control instruction to the execution module;
the execution module is used for executing an action corresponding to the first control instruction, and after executing the action, generating a second control instruction and sending the second control instruction to a drone to make the drone execute the second control instruction.

In one embodiment, the method for constructing the safety prediction model comprises:
obtaining a network structure of a Long Short-Term Memory (LSTM) model;
optimizing an initial weight, threshold, and number of neurons in a hidden layer of the LSTM model network structure;
determining the number of wolves in a grey wolf population and the maximum number of iterations;
determining the position information of the grey wolf population; wherein, the position information of the grey wolf population comprises the position information of each wolf in the grey wolf population, which comprises the initial weight, threshold, and number of neurons in the hidden layer;
based on the position information of the grey wolf population, constructing the LSTM model and calculating the fitness of each wolf in the grey wolf population;
based on the fitness of each wolf, updating the fitness of the three highest social-ranked wolves in the grey wolf population;
based on the current iteration count and the position information of the three highest social-ranked wolves in the grey wolf population, updating the position information of the other wolves in the grey wolf population and calculating the position information of each wolf in the next iteration count of the current iteration count;
if the current iteration count is greater than or equal to the maximum number of iterations, obtaining the position information of the updated highest social-ranked wolf as an optimal hyperparameter for the LSTM model;
based on the optimal hyperparameter of the LSTM model, constructing the LSTM model to obtain the safety prediction model.

In one embodiment, updating the fitness of the three highest social-ranked wolves in the grey wolf population based on the fitness of each wolf comprises:
selecting three fitness values greater than a preset fitness value from the plurality of fitness values as target fitness values;
assigning the highest value in the target fitness values to a first social-ranked wolf in the grey wolf population; wherein, the first social-ranked wolf is the highest social-ranked wolf;
assigning the lowest value in the target fitness values to the third social-ranked wolf in the grey wolf population;
assigning the remaining value in the target fitness values to the second social-ranked wolf in the grey wolf population; wherein, the rank of the first social-ranked wolf is higher than the rank of the second social-ranked wolf, which is higher than the rank of the third social-ranked wolf.

In one embodiment, the detection module at least comprises a water level detection unit, a lightning detection unit, and a weather parameter detection unit;
wherein, the water level detection unit is used for detecting water level information within a preset range of the hangar to obtain the water level information;
the lightning detection unit is used for detecting lightning information to obtain the lightning information;
the weather parameter detection unit is used for detecting environmental weather information to obtain the environmental weather information, the environmental weather information comprising temperature, rainfall, snowfall, wind speed, and wind direction.

In one embodiment, generating the first control instruction based on the safety parameter comprises:
if the safety parameter is a first safety parameter and the current safety parameter corresponding to the current time period is a second safety parameter, obtaining an end time of the current time period; wherein, the risk level of the first safety parameter is lower than the risk level of the second safety parameter;
based on the end time of the current time period, generating a first opening instruction; wherein, the first opening instruction is to open the drone hangar at the end time of the current time period;
wherein, after executing the action, generating a second control instruction, and sending the second control instruction to the drone comprises:
after executing the action, generating a takeoff instruction and sending the takeoff instruction to the drone, so that the drone can take off.

In one embodiment, generating the first control instruction based on the safety parameter comprises:
dividing a next time period of the current time period to obtain a plurality of first future moments;
determining the safety parameter corresponding to each first future moment;
if there are more than or equal to a preset number of consecutive moments in the plurality of first future moments having the same safety parameters, and the same safety parameters are a third risk parameter, generating a second opening instruction;
if there are more than or equal to a preset number of consecutive moments in the plurality of first future moments having the same safety parameters, and the same safety parameters are a fourth risk parameter, generating a first closing instruction; wherein, the risk level of the third risk parameter is lower than the risk parameter of the fourth risk parameter.

In one embodiment, generating the first control instruction based on the safety parameter comprises:
dividing a next time period of the current time period to obtain a plurality of second future moments;
determining the safety parameter corresponding to each second future moment;
if there are at least two consecutive moments in the plurality of second future moments having the same safety parameter, the time period formed by the at least two consecutive moments is greater than a preset time period, and the same safety parameter is a fifth safety parameter, generating a third opening instruction;
if there are at least two consecutive moments in the plurality of second future moments having the same safety parameter, the time period formed by the at least two consecutive moments is greater than the preset time period, and the same safety parameter is a sixth safety parameter, generating a second closing instruction; wherein, the risk level of the fifth safety parameter is lower than the risk level of the sixth safety parameter.

In one embodiment, the execution module comprises a fire protection module, the fire protection module used for activating fire protection equipment when a fire is detected in the drone hangar or when the temperature in the drone hangar exceeds a preset value.

In one embodiment, the execution module at least comprises a servo driver and a motor, the servo driver connected to the motor; the servo driver and the control module transmit data via a communication protocol; the servo driver is used for controlling the motor to perform operational logic actions based on control instructions of the control module.

The control equipment for a drone hangar provided by the present application comprises: a control system at least comprising: a control module, an execution module, and a detection module, wherein, the control module is separately communicatively connected to the execution module and the detection module; the detection module is used for collecting operational execution safety parameters for a current time period, wherein, the operational execution safety parameters comprise various environmental information, the environmental information comprising water level information, lightning information, and weather information, the weather information comprising temperature, rainfall, snowfall, wind speed, and wind direction; obtaining historical operational execution safety parameters for historical time periods; wherein, the historical safety parameters comprise various historical environmental information, the environmental information comprising historical water level information, historical lightning information, and historical weather information, the historical weather information comprising historical temperature, historical rainfall, historical snowfall, historical wind speed, and historical wind direction; constructing a time series based on the water level information, lightning information, weather information, historical water level information, historical lightning information, and historical weather information; wherein, the time series has corresponding safety parameter trend data; at the same time, determining a safety parameter for a next time period of the current time period based on the time series, safety parameter trend data, and a safety prediction model; the control module is used for generating a first control instruction based on the safety parameter, and sending the first control instruction to the execution module; the execution module is used for executing an action corresponding to the first control instruction, and after executing the action, generating a second control instruction and sending the second control instruction to a drone to make the drone execute the second control instruction. By inputting the operational execution safety parameters of the historical time period and the operational execution safety parameters of the current time period into the safety prediction model, the safety parameter for the future time period is predicted, and then the drone hangar is controlled based on the parameter of the future time period to ensure that the drone hangar can operate safely, thereby ensuring the safety of the drone flight. Furthermore, by predicting the safety parameter for the future time period, the operational efficiency of the drone hangar and the flight efficiency of the drone are ensured. In addition, the present application improves the accuracy of predicting the safety parameter by constructing the safety prediction model.

### BRIEF DESCRIPTION OF THE DRAWINGS

In order to more clearly explain the technical solutions of the embodiments of the present application, the figures used in the embodiments of the present application are briefly introduced below. It should be understood that the following figures only illustrate certain embodiments of the present application, and therefore should not be considered as limitations on the scope. For those skilled in the art, other relevant figures can be obtained based on these figures without creative effort.

FIG. 1 is a structural block diagram of control equipment for a drone hangar provided by an embodiment of the present application;

FIG. 2 is another structural block diagram of control equipment for a drone hangar provided by an embodiment of the present application.

### DETAILED DESCRIPTION OF EMBODIMENTS

The following describes the technical solutions in the present application with reference to the accompanying figures in the embodiments of the present application.

The Long Short-Term Memory (LSTM) network is a special architecture of Recurrent Neural Networks (RNN), designed to address the vanishing gradient and exploding gradient problems encountered by RNNs when processing long sequence data.

The Sigmoid function is a logistic function with an output range between 0 and 1.

The Tanh function is a hyperbolic tangent function with an output range between −1 and 1. Unlike the Sigmoid function, the Tanh function is usually not directly used as a gating function to control the on/off switching of information, but rather to generate candidate values or adjust the strength of the information.

It should be noted that similar reference numbers and letters in the accompanying figures represent similar items. Therefore, once an item has been defined in one figure, it does not need to be further defined or explained in subsequent figures. Additionally, in the description of the present application, terms such as “first”, “second”, etc. are used only for distinguishing descriptions, and should not be interpreted as indicating or implying relative importance.

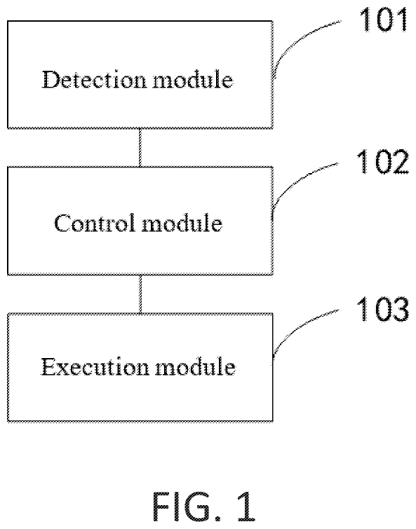

Please refer to FIG. 1, which is a structural block diagram of control equipment for a drone hangar provided by an embodiment of the present application. The control equipment of the drone hangar comprises at least the following components: a control module 102, an execution module 103, and a detection module 101, wherein, the control module 102 is separately communicatively connected to the execution module 103 and the detection module 101.

The detection module 101 is used for collecting operational execution safety parameters for a current time period, wherein, the operational execution safety parameters comprise various environmental information, the environmental information comprising water level information, lightning information, and weather information, the weather information comprising temperature, rainfall, snowfall, wind speed, and wind direction;

Obtaining historical operational execution safety parameters for historical time periods; wherein, the historical safety parameters comprise various historical environmental information, the environmental information comprising historical water level information, historical lightning information, and historical weather information, the historical weather information comprising historical temperature, historical rainfall, historical snowfall, historical wind speed, and historical wind direction; constructing a time series based on the water level information, lightning information, weather information, historical water level information, historical lightning information, and historical weather information; wherein, the time series has corresponding safety parameter trend data; at the same time, determining a safety parameter for a next time period of the current time period based on the time series, safety parameter trend data, and a safety prediction model; the control module 102 is used for generating a first control instruction based on the safety parameters, and sending the first control instruction to the execution module 103; the execution module 103 is used for executing an action corresponding to the first control instruction, and after executing the action, generating a second control instruction and sending the second control instruction to the drone to make the drone execute the second control instruction.

In an embodiment of the present application, in order to predict whether the drone hangar can be safely opened in the next time period of the current time period, the present application constructs a safety prediction model, and through the safety prediction model, predicts the next time period of the current time period, which is the future time period, to determine whether the drone hangar can be safely opened, thereby ensuring the safety of the drone flight. Furthermore, if it is safe to open the drone hangar in the future time period, the opening instruction can also be executed in the current time period, thereby improving the efficiency of opening the drone hangar and further ensuring the efficiency of drone operations.

The present application constructs a time series from the historical safety parameters of the historical time period and the historical safety parameters of the current time period, so that the model can capture the time correlation between the historical safety parameters of the historical time period and the historical safety parameters of the current time period. Then, by performing processes such as normalization and denoising, a clean time series can be generated to prevent interference features from affecting the prediction results of the model.

Secondly, based on the historical safety parameters of the historical time period and the current safety parameters of the current time period, safety parameter trend data is constructed. For example, if the historical safety parameters of the historical time period are high-risk parameters and the current safety parameters of the current time period are low-risk parameters, then the safety parameter trend data shows a trend from high risk to low risk. To allow the safety prediction model to better recognize safety parameter trend data, the safety parameter trend data can be numerically converted. The present application sets high-risk parameters to correspond to 1 and low-risk parameters to correspond to 0, so the safety parameter trend data is 1-0. The result output by the safety prediction model can also be 1 or 0. Then, based on the number, it can be determined whether the safety parameter is a high-risk parameter or a low-risk parameter. Alternatively, the result output by the safety prediction model is a probability value of 1. The risk level for opening the drone hangar in the future time period can be further determined through the probability value. Since the LSTM model uses the Sigmoid function, the probability value in the present application can be achieved through the Sigmoid function.

In the present application, setting high-risk and low-risk parameters aims to more accurately control the opening of the drone hangar and ensure the safety of opening the drone hangar, as well as the safety of the drone flight, wherein, if the safety parameter is a high-risk parameter, it indicates that opening the drone hangar in the future time period has a high risk, and the drone operation also has a high risk. Therefore, a closing instruction should be generated to stop the operation of the drone hangar, and a stop-flight instruction should be generated so that the drone does not need to take off. If the safety parameter is a low-risk parameter, it indicates that the risk of opening the drone hangar in the future time period is low, so an opening instruction should be generated to activate the operation of the drone hangar, and a take-off instruction should be generated for the drone to execute the take-off instruction and take off, wherein, the second control instruction comprises a stop-flight instruction or a take-off instruction.

Additionally, if the safety parameter for the future time period is high-risk parameter and the current safety parameter for the current time period is a low-risk parameter, that is, if there is a change in the trend of the safety parameters from low risk to high risk, then, to protect the safety of the drone flight after the drone hangar is opened, if the future time period has a high-risk safety parameter while the current time period has a low-risk safety parameter, a third closing instruction is generated, and the drone hangar is closed during the current time period to prevent damage to the drone hangar and the drone caused by the early onset of adverse environmental conditions in the future. A stop-flight instruction is then generated, and the drone executes the stop-flight instruction to not take off, thereby ensuring the safety of the drone.

Similarly, based on the safety parameters, generating the first control instruction comprises: if the safety parameter is a first safety parameter and the current safety parameter corresponding to the current time period is a second safety parameter, obtaining an end time of the current time period; wherein, the risk level of the first safety parameter is lower than the risk level of the second safety parameter; based on the end time of the current time period, generating a first opening instruction; wherein, the first opening instruction is to open the drone hangar at the end time of the current time period; wherein, after executing the action, generating a second control instruction, and sending the second control instruction to the drone comprises: after executing the action, generating a takeoff instruction and sending the takeoff instruction to the drone, so that the drone can take off.

If the safety parameter for the future time period is the low-risk parameter and the current safety parameter for the current time period is the high-risk parameter, then at the end time of the current time period or at the end moment, an opening instruction is generated, causing the drone hangar to activate operating, and then a takeoff instruction is generated, and the drone executes the takeoff instruction and takes off. At this point, the drone taking off will not cause any damage to the drone. This is because the adverse environment at the end time or during the end period will gradually transition into a safe environment. In other words, during the buffer period at the end time or the end period, the intensity or destructive force of the adverse environment will gradually weaken. Therefore, opening the drone hangar during this buffer period and controlling the flight operations of the drone will not cause damage to the drone hangar or the drone, thereby improving the efficiency of using the drone hangar as well as the efficiency of the operations and the safety of flight of the drone.

Finally, the time series and the safety parameter trend data are input into the safety prediction model together, thereby predicting the safety parameter for the future time period, and determining whether the safety parameter is the low-risk parameter or the high-risk parameter. Then, based on the low-risk and high-risk parameters, the safety of activation of the drone hangar during the future time period is determined, which further determines the safety of the drone taking off. The safety parameter for the future time period can also be used to protect the drone hangar in advance, thereby preventing damage to the drone hangar and the drone flight caused by the early occurrence of adverse environments. The safety parameter for the future time period can also be used to activate the drone hangar in advance based on the safety parameters for the future time period, thereby improving the operational efficiency of the drone hangar and providing safety protection for the drone.

In one embodiment, the method of constructing the safety prediction model comprises: obtaining the network structure of the LSTM model; optimizing the initial weight, threshold, and number of neurons in the hidden layer of the LSTM model network structure; determining the number of wolves in the grey wolf population and the maximum number of iterations; determining the position information of the grey wolf population; wherein, the position information of the grey wolf population comprises the position information of each wolf in the grey wolf population, which comprises the initial weight, threshold, and number of neurons in the hidden layer; based on the position information of the grey wolf population, constructing the LSTM model and calculating the fitness of each wolf in the grey wolf population; based on the fitness of each wolf, updating the fitness of the three highest social-ranked wolves in the grey wolf population; based on the current iteration count and the position information of the three highest social-ranked wolves in the grey wolf population, updating the position information of the other wolves in the grey wolf population and calculating the position information of each wolf in the next iteration count of the current iteration count; if the current iteration count is greater than or equal to the maximum number of iterations, obtaining the position information of the updated highest social-ranked wolf as an optimal hyperparameter for the LSTM model; based on the optimal hyperparameter of the LSTM model, constructing the LSTM model to obtain the safety prediction model.

In an embodiment of the present application, in order to improve the accuracy of predicting the safety parameter for the future time period, the present application generates the optimal hyperparameter to enhance the efficiency and accuracy of prediction by the LSTM model.

Specifically, the present application first determines the parameters to be optimized, that is, the specific parameters that need to be optimized in the LSTM model. By obtaining the network structure of the LSTM model, the initial weight, threshold, and number of neurons in the hidden layer of each gated function in the network structure of the LSTM model can be acquired. Wherein, the formula for calculating the initial weight is: w=4×neuron×in+4×neuron×neuron+ . . . +4×neuron×out, wherein, “neuron” represents the number of neurons in the hidden layer, “in” represents the number of input layers, “out” represents the number of output layers, and “4” represents the four gates in LSTM. The formula for calculating the threshold is: b=4×neuron+out, wherein, “neuron” represents the number of neurons in the hidden layer, and 4 represents the four gates in LSTM, which comprise three sigmoid gates and one tanh gate. The threshold can be considered as a bias vector b.

Then, the number of wolves in the grey wolf population and the maximum number of iterations can be manually set, or the number of wolves in the grey wolf population and the maximum number of iterations can be randomly generated through machine algorithms, and the position information of the grey wolf population can be set, specifically setting the position information of each wolf in the grey wolf population, which comprises the initial weight, threshold, and number of neurons in the hidden layer, wherein, the position information of each wolf is expressed as:
P(i)∈[w, b, neuron], i=1, 2, . . . , N, wherein, “N” is the number of wolves in each grey wolf population. The position information of the grey wolf population is divided into a training set and a validation set. Wherein, the position information of each wolf in the training set is decomposed into a W weight matrix, U weight matrix, and threshold b (bias vector b), and the same applies to the validation set. Then, the training set is input into the LSTM model, and a prediction result of the next position information for each wolf is output. Based on the prediction result and the actual result of the position information of each wolf, and using mean squared error (MSE), mean absolute error (MAE), etc., the fitness of each wolf is calculated. Based on the fitness of each wolf, the fitness of the three highest social-ranked wolves in the grey wolf population is updated. Wherein, the W weight matrix generally represents the connection weights between the internal state vector or tensor of the hidden layer and the neurons in the hidden layer. The U weight matrix represents the connection weights between the input layer and the hidden layer. It determines how the input data is converted into activation values in the hidden layer.

Next, the position information of each wolf in the grey wolf population is updated, and the current iteration count is updated, and then the fitness of each wolf in the grey wolf population is recalculated. Based on the fitness of each wolf, the fitness of the three highest social-ranked wolves in the grey wolf population is updated. Finally, when the current iteration count is greater than or equal to the maximum number of iterations, the position information of the updated highest social-ranked wolf is obtained as the optimal hyperparameter of the LSTM model. Using the optimal hyperparameter of the LSTM model, the LSTM model is constructed to obtain the safety prediction model, and the safety prediction model is then used to predict the safety parameter for the future time period.

Wherein, based on the current iteration count and the position information of the three highest social-ranked wolves in the grey wolf population, updating the position information of the other wolves in the grey wolf population and calculating the position information for each wolf in the next iteration count of the current iteration count comprises:

Sorting the grey wolf population according to fitness, and selecting the first social-ranked, second social-ranked, and third social-ranked wolves. Based on the social ranks and hunting mechanisms of the grey wolves, updating the positions of the other wolves. The next iteration is entered, and the above process is repeated until the preset iteration count is reached or other stopping conditions are met.

Specifically, suppose that three wolves in the grey wolf population know the potential location of prey, i.e., the first social-ranked wolf, the second social-ranked wolf, and the third social-ranked wolf. The positions of the other wolves are updated through the first social-ranked wolf, the second social-ranked wolf, and the third social-ranked wolf, and their mathematical expressions are as follows:
Position₁=|x₁D₁(t)−D(t)|;
Position₂=|x₂D₂(t)−D(t)|;
Position₃=|x₃D₃(t)−D(t)|;
D_{α}=D₁(t)−a₁D₁(t);
D_{β}=D₂(t)−a₂D₂(t);
D_{γ}=3(t)−a₃D₃(t);
D(t+1)=(D_{α}+D_{β}+D_{γ})/3;

Wherein, “D(t)” represents the current position of the grey wolf, “Position₁”, “Position₂”, and “Position₃” respectively represent the distance between the current grey wolf (other wolves or other grey wolves) and the first social-ranked wolf, second social-ranked wolf, and third social-ranked wolf at generation t, “D₁(t)”, “D₂(t)”, and “D₃(t)” are the position information of the first social-ranked wolf, second social-ranked wolf, and third social-ranked wolf at generation t, “D(t+1)” represents the position information of each wolf at generation t+1, and “t” represents the iteration number, wherein, a=2A·d₁−A, x=2·d₂, wherein, “A” (a convergence factor) linearly decreases from 2 to 0 as the iteration number increases. “d₁” and “d₂” are random number vectors in the range [0,1]. “a₁”, “a₂”, and “a₃” in the above formulas are calculated using the formula a=2A·d₁−A. “x₁”, “x₂”, and “x₃” are calculated using the formula x=2·d₂, wherein, “a” and “c” are coefficient vectors of synergy, used to control the movement direction and step size of the grey wolves. The present application updates the position information of each wolf in the next iteration of the grey wolf population using D(t+1)=(D_{α}+D_{β}+D_{γ})/3.

In one embodiment, generating the first control instruction based on the safety parameter comprises: dividing a next time period of the current time period to obtain a plurality of first future moments; determining the safety parameter corresponding to each first future moment; if there are more than or equal to a preset number of consecutive moments in the plurality of first future moments having the same safety parameters, and the same safety parameters are a third risk parameter, generating a second opening instruction; if there are more than or equal to a preset number of consecutive moments in the plurality of first future moments having the same safety parameters, and the same safety parameters are a fourth risk parameter, generating a first closing instruction; wherein, the risk level of the third risk parameter is lower than the risk parameter of the fourth risk parameter.

The present application can divide the future time period (the next time period of the current time period) into a plurality of first future moments, and the safety prediction model can predict the safety parameter corresponding to each first future moment. If there are a preset number of consecutive moments in the plurality of first future moments having the same safety parameter, and the same safety parameter is the third risk parameter, an opening instruction is generated to open the drone hangar. If there are a preset number of consecutive moments in the plurality of first future moments having the same safety parameter, and the same safety parameter is the fourth risk parameter, a first closing instruction is generated. The risk level corresponding to the third risk parameter is lower than the risk level corresponding to the fourth risk parameter.

For example, the plurality of first future moments comprise Moment A, Moment B, Moment C, Moment D, Moment E, Moment F, and Moment G. The risk parameter corresponding to Moment A is the third risk parameter, the risk parameter corresponding to Moment B is the fourth risk parameter, the risk parameter corresponding to Moment C is the third risk parameter, the risk parameter corresponding to Moment D is the third risk parameter, the risk parameter corresponding to Moment E is the fourth risk parameter, the risk parameter corresponding to Moment F is the third risk parameter, and the risk parameter corresponding to Moment G is the third risk parameter. As demonstrated, it can be seen that the risk parameters corresponding to Moment C and Moment D, and to Moment F and Moment G, are the same, and the times are consecutive. If the preset number is set to 2, then the number of moments in Moment C and Moment D is greater than the preset number of 2, and the number of moments in Moment F and Moment G is greater than the preset number of 2, so the second opening instruction should be generated.

In the above example, if the safety parameters for Moment B and Moment E are the fourth risk parameter, but the times are not consecutive, the first closing instruction cannot be generated.

In one embodiment, generating the first control instruction based on the safety parameter comprises: dividing the next time period of the current time period to obtain a plurality of second future moments; determining the safety parameter corresponding to each second future moment; if there are at least two consecutive moments in the plurality of second future moments having the same safety parameter, the time period formed by the at least two consecutive moments is greater than a preset time period, and the same safety parameter is a fifth safety parameter, generating a third opening instruction; if there are at least two consecutive moments in the plurality of second future moments having the same safety parameter, the time period formed by the at least two consecutive moments is greater than the preset time period, and the same safety parameter is a sixth safety parameter, generating a second closing instruction; wherein, the risk level of the fifth safety parameter is lower than the risk level of the sixth safety parameter.

The present application can divide the future time period (the next time period of the current time period) into a plurality of second future moments, and the safety prediction model can predict the safety parameter corresponding to each second future moment. If the time period formed by at least two consecutive moments is greater than the preset time period, and the same safety parameter is the fifth safety parameter, the third opening instruction is generated. If there are at least two consecutive moments in the plurality of second future moments having the same safety parameter, the time period formed by the at least two consecutive moments is greater than the preset time period, and the same safety parameter is the sixth safety parameter, the second closing instruction is generated, wherein, the risk level of the fifth safety parameter is lower than the risk level of the sixth safety parameter.

For example, the plurality of second future moments comprise Moment A, Moment B, Moment C, Moment D, Moment E, Moment F, and Moment G. The risk parameter corresponding to Moment A is the fifth risk parameter, the risk parameter corresponding to Moment B is the sixth risk parameter, the risk parameter corresponding to Moment C is the fifth risk parameter, the risk parameter corresponding to Moment D is the fifth risk parameter, the risk parameter corresponding to Moment E is the sixth risk parameter, the risk parameter corresponding to Moment F is the fifth risk parameter, and the risk parameter corresponding to Moment G is the fifth risk parameter. As demonstrated, it can be seen that the safety parameters corresponding to Moment C and Moment D, and to Moment F and Moment G, are the same, the times are consecutive, and Moment C and Moment D, and Moment F and Moment G form a time period composed of 4 moments. If the preset time period is set to 2, then the time period formed by Moment C and Moment D, and Moment F and Moment G satisfies the preset time period, and the second opening instruction should be generated.

It should be understood that the definition names of the low-risk parameter and high-risk parameter in the present application are not limited, but the risk level of low-risk parameter is lower than that of high-risk parameter.

In one embodiment, the control equipment of the drone hangar can be specifically implemented as: selecting three fitness values greater than a preset fitness value from the plurality of fitness values as target fitness values; assigning the highest value in the target fitness values to the first social-ranked wolf in the grey wolf population; wherein, the first social-ranked wolf is the highest social-ranked wolf; assigning the lowest value in the target fitness values to the third social-ranked wolf in the grey wolf population; assigning the remaining value in the target fitness values to the second social-ranked wolf in the grey wolf population; wherein, the rank of the first social-ranked wolf is higher than the rank of the second social-ranked wolf, which is higher than the rank of the third social-ranked wolf.

In an embodiment of the present application, the present application selects the three highest fitness values from the plurality of fitness values and assigns them to the first social-ranked wolf, second social-ranked wolf, and third social-ranked wolf, respectively. Furthermore, the largest of the three fitness values is assigned to the first social-ranked wolf, and the smallest of the three fitness values is assigned to the third social-ranked wolf. Then, through continuous iteration, the position information corresponding to the first social-ranked wolf is finally selected as the optimal hyperparameter of the LSTM model.

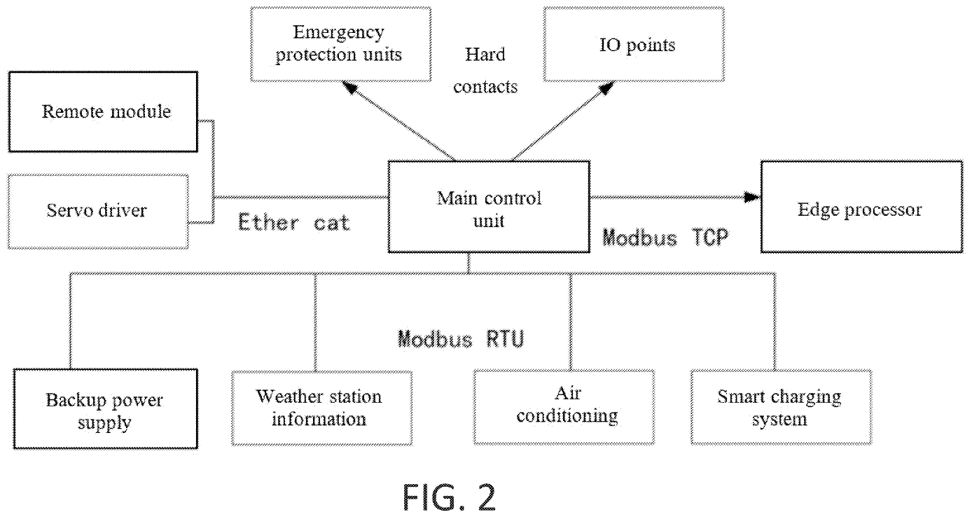

FIG. 2 is a block diagram of control equipment of another drone hangar provided by an embodiment of the present application. As shown in FIG. 2, optionally, the detection module at least comprises a water level detection unit, a lightning detection unit, and a weather parameter detection unit; wherein, the water level detection unit is used for detecting water level information within a preset range of the hangar to obtain the water level information;

The lightning detection unit is used for detecting lightning information to obtain the lightning information;

The weather parameter detection unit is used for detecting environmental weather information to obtain the environmental weather information, the environmental weather information comprising temperature, rainfall, snowfall, wind speed, and wind direction.

In an embodiment of the present application, two water level detection sensors are added, i.e., emergency protection units, to ensure emergency power cut-off when the device is flooded by heavy rain. The operating principle is: when an action signal of sensor 1 exceeds 1 minute (the time can be set), a main control unit will report a water ingress warning for the device. If both sensor 1 and sensor 2 exceed a preset value, such as 1 minute, the power will be cut off.

The drone hangar is directly placed outdoors, so a first-level lightning protection device is used (direct lightning protection, mainly used for protecting electrical control components and other facilities inside the hangar);

Through a weather station, the external environmental weather is monitored in real time, such as temperature, rainfall, snowfall, wind speed, and wind direction. The main control unit in the drone hangar obtains weather information via MODBUS 485 communication and determines whether the external environment meets the requirements for drone takeoff and landing, as well as the flight direction for takeoff.

In some embodiments of the present application, by setting the detection module, comprising the water level detection unit, lightning detection unit, and weather parameter detection unit, various environmental parameters can be obtained for real-time monitoring of the environment of the drone hangar.

Optionally, the execution module further comprises a power module. The power module is connected to the control module. The power module is used for providing power with different voltages.

The power module in the drone hangar can support AC110v/60 Hz or AC220v/50 Hz alternating current. Due to different voltage levels, matching devices must be selected to ensure the normal operation of the different voltage levels.

In some embodiments of the present application, a power module is further provided. Due to the different voltage levels, matching devices must be selected to ensure the normal operation of the different voltage levels.

Optionally, the execution module further comprises a backup power supply. The backup power supply is used for providing power to each module of the control equipment in the drone hangar when the power module is not working.

An embodiment of the present application not only comprises the power module, but further comprises the backup power supply, that is, a UPS power supply, and further comprises a quasi-redundant power distribution to ensure the safety and stability of the main control unit and monitoring equipment. Other actuators and sensors can support the execution of tasks several times within 4 hours after the mains power is disconnected to deal with emergencies.

In some embodiments of the present application, the backup or power supply is further used for ensuring the safety and stability of the main control unit and monitoring equipment.

Optionally, the execution module further comprises a switch module. The switch module is used for cutting off or connecting power in case of a control system failure or power restoration.

In some embodiments of the present application, when the equipment experiences an abnormality or power restoration, it supports manual remote power-off and power-on functions to reduce the disadvantages caused by the inability to promptly turn the power on or off due to the remote location of the hangar.

Optionally, the execution module further comprises a fire protection module. The fire protection module is used for activating fire protection equipment when a fire is detected in the drone hangar or when the temperature in the drone hangar exceeds a preset value.

In some embodiments of the present application, the drone hangar is equipped with a fire extinguishing device, and when there is fire or excessively high temperature in the hangar, the fire protection device can automatically take effect, or can also be remotely controlled manually to activate the fire protection device.

Optionally, the execution module at least comprises a servo driver and a motor. The servo driver is connected to the motor. The servo driver and the control module transmit data via a communication protocol;

The servo driver is used for controlling the motor to perform operational logic actions based on control instructions of the control module.

The servo driver communicates with a remote module via ether cat to receive and return signals, executing operational logic actions through the servo motor. The high-precision and stable operation effectively ensures the normal flow of operational processes.

In some embodiments of the present application, the servo driver communicates with a remote module via ether cat to receive and return signals, executing operational logic actions through the servo motor. The high-precision and stable operation effectively ensures the normal flow of operational processes.

Optionally, the execution module further comprises a charging module. The charging module communicates with the control module via MODBUS 485. The charging module is used for receiving charging and discharging instructions sent by the control module, and performing charging and discharging operations on the battery based on the charging and discharging instructions.

The battery charger communicates with the remote module via MODBUS 485 to receive charging and discharging instructions from the remote module and perform charging and discharging operations on the battery to meet the battery usage requirements of the drone.

The modules in the control equipment of the drone hangar in the present application receive the charging and discharging instructions from the control module and perform charging and discharging operations on the battery to meet the battery usage requirements of the drone.

Optionally, the execution module further comprises a main control module. The main control module communicates with the control module via a serial port. The main control module is used for receiving hangar status information sent by the control module and displaying the hangar status information.

An edge processor communicates with the remote module via a serial port, such as the MODBUS communication protocol. The edge processor issues takeoff/landing instructions, and the remote module serves as the controller of the device to control the mechanism to perform actions, while simultaneously transmitting the hangar status information in real-time to the edge processor, which is ultimately displayed on a client terminal for a user, wherein, the edge processor is an edge processor of IoT and the device.

In the present application, the main control module in the control equipment of the drone hangar communicates with the control module via a serial port. The main control module issues takeoff/landing instructions, and the control module serves as the controller of the device to control the mechanism to perform actions, while simultaneously transmitting the hangar status information in real-time to the main control module, which is ultimately displayed on the client for the user.

Optionally, the execution module further comprises a display module. The display module is connected to the control module. The display module is used for displaying different colored lights based on different hangar status information.

The display module can display different color lighting effects according to different hangar statuses or by manual control, to achieve aesthetics and real-time display of system status.

In some embodiments of the present application, different color lighting effects can be displayed according to different hangar statuses or by manual control, to achieve aesthetics and real-time display of system status.

The execution module further comprises a heater. The main control unit monitors the hangar temperature in real-time, turning an air conditioner and heater on or off according to a set temperature, ensuring that the internal temperature of the hangar is in the optimal state, thereby extending the lifespan of various equipment.

In an embodiment of the present application, a stable and reliable electrical control system is particularly important. It can effectively avoid situations where tasks cannot be performed normally in harsh environments such as plateaus, low temperatures, or high temperatures. The present application further comprises emergency protection functions, remote power-off and power-on control, and both autonomous and manual fire extinguishing designs to ensure the safety of equipment and power consumption of the hangar.

In summary, the execution module controls the opening or closing of different functional modules of the drone hangar through instructions, thereby ensuring the safety of the drone hangar. These functional modules comprise: the water level detection unit, lightning detection unit, weather parameter detection unit, power module, backup power, switch module, fire protection module, servo driver and motor, and charging module.

In several embodiments provided by the present application, it should be understood that the disclosed devices and methods can also be implemented in other ways. The device embodiments described above are merely illustrative. For example, the flowcharts and block diagrams in the figures show the possible system architectures, functions, and operations for devices, methods, and computer program products according to the plurality of embodiments of the present application. In this regard, each block in the flowcharts or block diagrams may represent a module, program segment, or part of a code. The module, program segment, or part of a code comprises one or more executable instructions for performing specified logical functions. It should also be noted that, in some alternative implementations, the functions noted in the blocks may occur in an order different from that shown in the figures. For example, two blocks that are shown consecutively may be executed substantially in parallel, or they may sometimes be executed in the reverse order, depending on the functions involved. It should also be noted that, each block in the block diagrams and/or flowcharts, as well as combinations of blocks in the block diagrams and/or flowcharts, can be implemented by a specialized hardware-based system that performs the specified functions or actions, or by a combination of specialized hardware and computer instructions.

Additionally, in the various embodiments of the present application, the functional modules can be integrated together to form an independent part, or each module can exist independently, or two or more modules can be integrated together to form an independent part.

If the functions are implemented in the form of software modules and sold or used as independent products, they can be stored in a computer-readable storage medium. Based on this understanding, the technical solutions of the present application, or the parts that contribute to the prior art, can essentially be embodied in the form of software products. This computer software product is stored in a storage medium, comprising several instructions to enable a computer device (which can be a personal computer, server, network device, etc.) to execute all or part of the steps of the methods described in various embodiments of the present application. The aforementioned storage medium comprises: USB flash drives, mobile hard drives, read-only memory (ROM), random-access memory (RAM), magnetic disks, optical discs, and other media that can store program codes.

The above description is only for the embodiments of the present application and is not intended to limit the scope of protection of the present application. For those skilled in the art, the present application may have various modifications and changes. Any modifications, equivalent replacements, improvements, etc., made within the spirit and principles of the present application should be included within the scope of protection of the present application. It should be noted that, similar reference numerals and letters in the following figures indicate similar items. Therefore, once an item is defined in one figure, there is no need to further define or explain it in subsequent figures.

The above description is only the specific embodiments of the present application, but the scope of protection of the present application is not limited thereto. Any variations or substitutions that can be easily thought of by anyone skilled in the technical field within the scope of disclosure of the present application should be covered by the scope of protection of the present application. Therefore, the scope of protection of the present application should be defined by the scope of the claims.

It should be noted that the relational terms such as “first” and “second” are only used to distinguish one entity or operation from another entity or operation, and do not necessarily require or imply any actual relationship or order between these entities or operations. Furthermore, the terms “comprising,” “including,” or any other variations are intended to cover non-exclusive inclusion so that a process, method, article, or apparatus that comprises a series of elements not only comprises those elements, but may also comprise other elements not explicitly listed, or elements that are inherent to such processes, methods, articles, or apparatuses. Without further limitations, elements defined by the phrase “comprising a . . . ” do not exclude the presence of additional identical elements in the process, method, article, or apparatus that comprises the elements.

1. Control equipment for a drone hangar, characterized in that, a control system at least comprises: a control module, an execution module, and a detection module, wherein, the control module is separately communicatively connected to the execution module and the detection module;
the detection module is used for collecting operational execution safety parameters for a current time period, wherein, the operational execution safety parameters comprise various environmental information, the environmental information comprising water level information, lightning information, and weather information, the weather information comprising temperature, rainfall, snowfall, wind speed, and wind direction;
obtaining historical operational execution safety parameters for historical time periods; wherein, the historical safety parameters comprise various historical environmental information, the environmental information comprising historical water level information, historical lightning information, and historical weather information, the historical weather information comprising historical temperature, historical rainfall, historical snowfall, historical wind speed, and historical wind direction;
constructing a time series based on the water level information, lightning information, weather information, historical water level information, historical lightning information, and historical weather information; wherein, the time series has corresponding safety parameter trend data;
at the same time, determining a safety parameter for a next time period of the current time period based on the time series, safety parameter trend data, and a safety prediction model;
the control module is used for generating a first control instruction based on the safety parameter, and sending the first control instruction to the execution module;
the execution module is used for executing an action corresponding to the first control instruction, and after executing the action, generating a second control instruction and sending the second control instruction to a drone to make the drone execute the second control instruction.

2. The control equipment for a drone hangar according to claim 1, characterized in that, a method for constructing the safety prediction model comprises:
obtaining a network structure of a LSTM model;
optimizing an initial weight, threshold, and number of neurons in a hidden layer of the LSTM model network structure;
determining the number of wolves in a grey wolf population and the maximum number of iterations;
determining position information of the grey wolf population; wherein, the position information of the grey wolf population comprises the position information of each wolf in the grey wolf population, which comprises the initial weight, threshold, and number of neurons in the hidden layer;
based on the position information of the grey wolf population, constructing the LSTM model and calculating fitness of each wolf in the grey wolf population;
based on the fitness of each wolf, updating the fitness of three highest social-ranked wolves in the grey wolf population;
based on a current iteration count and the position information of the three highest social-ranked wolves in the grey wolf population, updating the position information of the other wolves in the grey wolf population and calculating the position information of each wolf in the next iteration count of the current iteration count;
if the current iteration count is greater than or equal to the maximum number of iterations, obtaining the position information of an updated highest social-ranked wolf as an optimal hyperparameter for the LSTM model;
based on the optimal hyperparameter of the LSTM model, constructing the LSTM model to obtain the safety prediction model.

3. The control equipment for a drone hangar according to claim 2, characterized in that, updating the fitness of the three highest social-ranked wolves in the grey wolf population based on the fitness of each wolf comprises:
selecting three fitness values greater than a preset fitness value from a plurality of fitness values as target fitness values;
assigning the highest value in the target fitness values to a first social-ranked wolf in the grey wolf population; wherein, the first social-ranked wolf is the highest social-ranked wolf;
assigning the lowest value in the target fitness values to a third social-ranked wolf in the grey wolf population;
assigning the remaining value in the target fitness values to a second social-ranked wolf in the grey wolf population; wherein, the rank of the first social-ranked wolf is higher than the rank of the second social-ranked wolf, which is higher than the rank of the third social-ranked wolf.

4. The control equipment for a drone hangar according to claim 1, characterized in that, the detection module at least comprises a water level detection unit, a lightning detection unit, and a weather parameter detection unit;
wherein, the water level detection unit is used for detecting water level information within a preset range of the hangar to obtain the water level information;
the lightning detection unit is used for detecting lightning information to obtain the lightning information;
the weather parameter detection unit is used for detecting environmental weather information to obtain the environmental weather information, the environmental weather information comprising temperature, rainfall, snowfall, wind speed, and wind direction.

5. The control equipment for a drone hangar according to claim 1, characterized in that, generating the first control instruction based on the safety parameter comprises:
if the safety parameter is a first safety parameter and the current safety parameter corresponding to the current time period is a second safety parameter, obtaining an end time of the current time period; wherein, a risk level of the first safety parameter is lower than the risk level of the second safety parameter;
based on the end time of the current time period, generating a first opening instruction; wherein, the first opening instruction is to open the drone hangar at the end time of the current time period;
wherein, after executing the action, generating a second control instruction, and sending the second control instruction to the drone comprises:
after executing the action, generating a takeoff instruction and sending the takeoff instruction to the drone, so that the drone can take off.

6. The control equipment for a drone hangar according to claim 1, characterized in that, generating the first control instruction based on the safety parameter comprises:
dividing a next time period of the current time period to obtain a plurality of first future moments;
determining the safety parameter corresponding to each first future moment;
if there are more than or equal to a preset number of consecutive moments in the plurality of first future moments having the same safety parameters, and the same safety parameters are a third risk parameter, generating a second opening instruction;
if there are more than or equal to a preset number of consecutive moments in the plurality of first future moments having the same safety parameters, and the same safety parameters are a fourth risk parameter, generating a first closing instruction; wherein, the risk level of the third risk parameter is lower than the risk parameter of the fourth risk parameter.

7. The control equipment for a drone hangar according to claim 1, characterized in that, generating the first control instruction based on the safety parameter comprises:
dividing a next time period of the current time period to obtain a plurality of second future moments;
determining the safety parameter corresponding to each second future moment;
if there are at least two consecutive moments in the plurality of second future moments having the same safety parameter, the time period formed by the at least two consecutive moments is greater than a preset time period, and the same safety parameter is a fifth safety parameter, generating a third opening instruction;
if there are at least two consecutive moments in the plurality of second future moments having the same safety parameter, the time period formed by the at least two consecutive moments is greater than the preset time period, and the same safety parameter is a sixth safety parameter, generating a second closing instruction; wherein, the risk level of the fifth safety parameter is lower than the risk level of the sixth safety parameter.

8. The control equipment for a drone hangar according to claim 1, characterized in that, the execution module comprises a fire protection module, the fire protection module used for activating fire protection equipment when a fire is detected in the drone hangar or when the temperature in the drone hangar exceeds a preset value.

9. The control equipment for a drone hangar according to claim 1, characterized in that, the execution module at least comprises a servo driver and a motor, the servo driver connected to the motor; the servo driver and the control module transmit data via a communication protocol;
the servo driver is used for controlling the motor to perform operational logic actions based on control instructions of the control module.

10. The control equipment for a drone hangar according to claim 1, characterized in that, the execution module comprises a charging module, the charging module communicating with the control module via a serial port, the charging module used for receiving charging and discharging instructions sent by the control module, and performing charging and discharging operations on a battery based on the charging and discharging instructions.
